(19) United States
(12) Patent Application Publication
(10) Pub. No.: US 2010/0310955 A1
(43) Pub. Date: Dec. 9, 2010

(54) COMBUSTION OF HYDROGEN IN FUEL CELL CATHODE UPON STARTUP

(76) Inventors: Venkateshwarlu Yadha, Manchester, CT (US); Marc Moran, Northampton, MA (US); Matthew Wilson, Groton, CT (US)

Correspondence Address: M P Williams, 210 Main Street, Manchester, CT, 06042, US

(21) Appl. No.: 12/734,764

(22) PCT Filed: Dec. 28, 2007
(86) PCT No.: PCT/US2007/026514

§ 371 Date: Aug. 19, 2010

(51) Int. Cl. H01M 8/04

(52) U.S. Cl. 429/429

(57) ABSTRACT

A fuel cell power plant (100) includes a stack of fuel cells (102), each having an electrolyte (101) between an anode (104), and a cathode (106), coolant channels (103), an air blower (144), air inlet and outlet valves (139a, 141a), a cathode recycle loop an (135) using the air blower, and a cathode exhaust mix box (173). Shutdown includes recycling cathode air while applying fresh fuel and recycled fuel through the anodes until oxygen is about is about 0.2 or less, or expiration of time. On startup, the air blower is started with the cathode recycle valve (135) open, and the air inlet valve is opened to allow about one-half of the flow of air used during normal operation, to cause hydrogen in the cathode to be gradually consumed, thereby avoiding H2 levels above lower flammability levels in the air outlet manifold. H2 is monitored at exhaust; full air flow is provided after H2 peaks.

### TECHNICAL FIELD

Startup of a fuel cell power plant, which has had the cathode and anode gas spaces with a small amount of hydrogen at equilibrium, includes flowing a small amount of oxygen into the cathode, thereby safely consuming hydrogen with the aid of the catalyst, so as to avoid hydrogen concentrations above the lower flammability limit level in the cathode exhaust. The flow may be steady or pulsed.

### BACKGROUND ART

In PEM fuel cell systems, it is well known that, when the electrical circuit is opened and there is no longer a load across the cell, such as upon and during shutdown of the cell, the presence of air on the cathode, coupled with hydrogen fuel remaining on the anode, often cause unacceptably high electrode potentials, resulting in oxidation and corrosion of catalysts and catalyst supports and attendant cell performance degradation. Inert gas has been used to purge both the anode flow field and the cathode flow fields immediately upon cell shutdown to passivate the anode and cathode so as to minimize or prevent such cell performance degradation.

It is desired to avoid the cost, space and weight required for storing and delivering a separate supply of inert gas to fuel cells, especially in automotive applications where compactness and low cost are critical, and where the system must be shut down and restarted frequently. In U.S. Pat. No. 6,635,370, a fuel cell system is shut down by disconnecting the primary load, shutting off the air flow, closing air inlet and air outlet valves and controlling the fuel flow into and out of the system in a manner that results in the fuel cell gases coming to equilibrium across the cells, with gas composition of a small amount of hydrogen, balance fuel cell inert gases, which do not react with hydrogen or oxygen within the fuel cell, and do not otherwise harm cell performance to any significant extent.

In the aforementioned patent, after disconnecting the primary load and shutting off the air supply to and exhaust from the cathode flow fields, fuel continues to be fed to the anode flow fields until the remaining oxidant is consumed. This oxidant consumption is aided by recycling gas from the cathode exit to the cathode inlet, and by having a small auxiliary load applied across the cell, which also quickly drives down the cathode potential. Recycling the cathode gas assures good mixing of the remaining gas in the cathode, so that oxygen will be spread more uniformly throughout the fuel cells and thereby be more quickly consumed.

As the cathode gas is recycled, hydrogen in the anode flow field diffuses to the cathode through the membrane so that the oxygen in the cathode flow field is consumed, resulting in a total lesser volume of oxygen in the cathode flow fields, with an increasing concentration of nitrogen and other gases found in the atmosphere.

The oxidant flow field will finally stabilize at atmospheric pressure, with a hydrogen concentration of between about 0% and 50%, balance fuel cell inert gases.

### SUMMARY

A startup procedure avoids the purging of high concentrations of hydrogen built up in cathode gas flow spaces, and particularly in cathode exit manifolds and other exhaust plumbing. The startup procedure includes flowing a small amount of air into the cathodes at startup. This safely consumes, with the aid of the catalyst, hydrogen remaining in the cathode gas spaces after shutdown. The hydrogen may have reached the cathode as a consequence of any form of shutdown procedure which results in residual hydrogen in the cathode.

The present process, as part of a routine for startup of a fuel cell power plant, includes operating the air blower, and opening the air inlet valve for a low flow of air to the cathodes, as the hydrogen content in the cathode exhaust (or other exit plumbing) is monitored by a hydrogen sensor. This continues until a peak of hydrogen concentration is reached and passed. The peak may be reached between about 15 seconds and 20 seconds, but the time may vary depending on the power plant's design specifics. In this process, the cathode exhaust may be opened to allow a steady flow of air through the cathodes, or the cathode exhaust may be opened and closed (or nearly closed) to allow a repetitive stream of pulses of air of short duration to flow through the cathodes. Such pulses may be on and off for one second or a few seconds, or as long as ten seconds, in a usual case. The pulses will generally increase the intermixing of the exiting diluted mixture with whatever ambient it reaches.

In systems having cathode gas recycle capability used during a shutdown procedure, the cathode gas recycle may be activated in this startup procedure along with the flow of a small amount of inlet air. Use of cathode recycle, if present, assures that the hydrogen in the cathode gas spaces more readily reaches the cathode catalyst where the hydrogen reacts with the oxygen brought in with the air.

Since the amount of hydrogen in the cathode flow spaces is limited, the amount of heat generated is easily tolerated.

The procedure herein may be used with systems employing a hydrogen supply to support the consumption of residual oxygen, with or without a cathode recycle blower, and with or without a cathode recycle loop.

Other variations will become more apparent in the light of the following detailed description of exemplary embodiments, as illustrated in the accompanying drawings.

### BRIEF DESCRIPTION OF THE DRAWINGS

FIG. 1 is a schematic diagram of a first embodiment of a fuel cell system that may be shut down in accordance with the procedure hereof.

FIG. 2 is an approximate plot of hydrogen concentration against time.

FIG. 3 is a fragmentary view of a modification to the embodiment of FIG. 1.

### MODE(S) OF IMPLEMENTATION

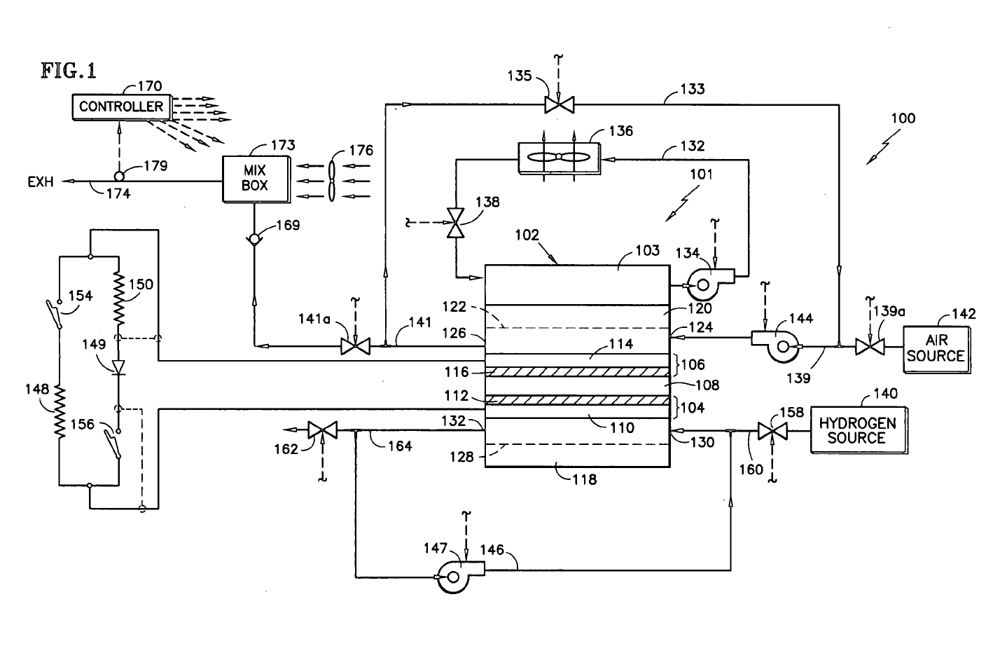

In FIG. 1, a fuel cell system 100 includes a stack 101 of adjacent fuel cells 102 connected electrically in series, having coolant flow fields 103 between the cathode flow field plate 120 of one cell and an anode flow field plate 118 of the adjacent cell. More detailed information regarding fuel cells like the one represented in FIG. 1, is available in U.S. Pat. No. 5,503,944. The '944 patent describes a solid polymer electrolyte fuel cell wherein the electrolyte is a proton exchange membrane (PEM).

The fuel cells 102 comprise anodes 104 (which may also be referred to as anode electrodes), and cathodes (which may also be referred to as cathode electrodes), and an electrolyte 108 disposed between each anode and cathode. Each electrolyte may be in the form of a proton exchange membrane (PEM), such as the type described in U.S. Pat. No. 6,024,848. Each anode includes an anode catalyst layer 112 disposed between an anode substrate 110 and the electrolyte 108. Each cathode includes a cathode catalyst layer 116 disposed between a cathode substrate 114 and the electrolyte 108. Each fuel cell also includes an anode flow field plate 118 adjacent the anode substrate 110 and a cathode flow field plate 120 adjacent the cathode substrate 114.

Each cathode flow field plate 120 has a plurality of channels 122 extending thereacross adjacent the cathode substrate, forming a cathode flow field for carrying an oxidant, such as air, across the cathode from an inlet 124 to an outlet 126. Each anode flow field plate 118 has a plurality of channels 128 extending thereacross adjacent the anode substrate forming an anode flow field for carrying a hydrogen-containing fuel across the anode from an inlet 130 to an outlet 132. The stack 101 also includes coolant flow fields 131 between the reactant gas flow field plates 118, 120 for removing heat from the cells, such as by using a coolant pump 134 to circulate coolant through a loop 132 that passes through the coolant flow fields 131, a radiator 136 for rejecting the heat, and a flow control valve or orifice 138.

The fuel cell system of FIG. 1 includes a source 140 of hydrogen-containing fuel and a source 142 of air. The fuel may be high purity hydrogen or other hydrogen rich fuel, such as reformed natural gas or gasoline. A conduit 139 carries air from a source 142, typically the ambient surroundings, through an air inlet valve 139a, into the cathode flow field inlet 124; and a conduit 141 carries spent air away from the outlet 126 through an air exit valve 141a and a check-valve 169. An oxidant recycle loop 133, having an oxidant recycle valve 135 disposed therein extends to the inlet of an air blower 144 disposed within the conduit 139, to selectively circulate spent air from the cathode flow field outlet 126 back into the cathode flow field inlet 124 during a shutdown procedure or in this startup procedure. The blower 144 may operate at a lower speed when operating in a recycle mode, typically at about half the normal operation speed.

The fuel cell system also includes an external electrical circuit 148 connecting the anode and cathode, a fuel recycle loop 146, and a fuel recycle loop blower 147 disposed within the fuel recycle loop. The external circuit 143 includes a primary load 148, and an auxiliary resistive load 150 in parallel with the primary load, and a diode 149 in series with the auxiliary resistive load.

During normal fuel cell operation, a primary load switch 154 is closed (it is shown open in the drawing), and an auxiliary load switch 156 is open, such that the fuel cell is providing electricity to the primary load 154. The air blower 144, fuel recycle blower 147 and the coolant pump 134 are all on. The air flow valves 139a and 141a are open. A fuel feed valve 158 in a fuel feed conduit 160 to the anode flow fields is open, as is an anode exhaust vent valve 162 in an anode exhaust conduit 164, and the coolant loop flow control valve 138 is also open. The air recycle valve 135 is closed. These conditions are typically administered by a conventional controller 170.

During normal operation, air from the source 142 is continuously delivered into the cathode flow field inlet 124 via the conduit 139 and leaves the outlet 126 via the conduit 141. A hydrogen-containing fuel from the source 140 is continuously delivered into the anode flow field via the conduit 160. A portion of the anode exhaust, containing depleted hydrogen fuel, leaves the anode flow field through the vent valve 162 via the conduit 164, while the recycle blower 147 recirculates the balance of the anode exhaust through the anode flow field via the recycle loop. Recycling a portion of the anode exhaust helps maintain a relatively uniform gas composition from the inlet 130 to the outlet 132 of the anode flow field, and increases hydrogen utilization. As the hydrogen passes through the anode flow field, it electrochemically reacts on the anode catalyst layer in a well-known manner to produce hydrogen ions and electrons. The electrons flow from the anode 104 to the cathode 106 through the external circuit 143 to power the primary load 148.

To shut down the operating fuel cell system according to one “hydrogen-on” method, the switch 154 in the external circuit 143 is opened to disconnect the primary load 148. The fuel flow valve 158 remains open; and the fuel recycle blower remains on to continue recirculation of a portion of the anode exhaust. However, the anode exhaust vent valve 162 will remain open or be closed depending upon the percent hydrogen in the incoming fuel and the relative volumes of the anode and cathode sides of the fuel cell, as is explained below.

The flow of fresh air through the cathode flow field is turned off by closing the air exit valve 141a while the air blower 144 remains on, and the oxidant recycle valve 135 is opened to circulate air from the cathode flow field outlet 126 to the cathode flow field inlet 124. This creates a uniform gas composition within the cathode flow fields and ultimately helps speed the fuel cell gases to equilibrium within the cell. The auxiliary load 150 is connected by closing the switch 156. With current flowing through the auxiliary load, typical electrochemical cell reactions occur, causing the oxygen concentration in the cathode flow field to be reduced and cell voltage to be lowered. The hydrogen within the anode flow field supports the cell reaction that consumes the cathode oxygen, and somewhat more slowly diffuses across the electrolyte to the cathode for additional cathode oxygen consumption.

The application of the auxiliary load is preferably initiated while there is sufficient hydrogen within the fuel cell to electrochemically react the oxidant. The load may remain connected at least until either the cell voltage is lowered to a pre-selected value, about 0.2 volts per cell or less, or until the oxygen concentration in the cathode drops below about 4%, or until the hydrogen concentration in the cathode increases to near 50%, or for a predetermined fixed period of time. The diode 149, connected across the cathode and anode, senses the cell voltage and allows current to pass through the load 148 as long as the cell voltage is above the pre-selected value. In that way, the cell voltage is reduced to and thereafter limited to the pre-selected value. When the cell voltage drops to about 0.2 volts per cell, substantially all the oxygen within the cathode flow fields, and any that has diffused across the cell, will have been consumed. The auxiliary load may now be disconnected by opening the switch 156; but it may remain connected throughout the remainder of the shut down procedure to limit the cell voltage to no more than 0.2 volts per cell while the cell is shut down. In some utilizations of a hydrogen-on fuel cell stack shut down procedure, use of an auxiliary load may be omitted.

Whether the anode exhaust vent valve 162 needs to be open during the foregoing procedure is determined by the hydrogen concentration of the incoming fuel and the relative volumes of gas space on the anode and cathode sides of the cell. Whether and for how long the fuel needs to continue to flow as the oxygen is consumed is easily determined by persons having ordinary skill in the art, in view of further explanation in the aforementioned '370 patent.

Once all the oxygen within the anode and cathode flow fields is consumed, the fuel feed valve 158 and the anode exhaust vent valve 162, if open, are shut. The fuel recycle pump 147, the oxidant recycle valve 135, and the coolant pump 134 may now be shut off. However, it may be useful to keep the auxiliary load switch 156 closed. In some circumstances the anode exhaust vent valve may not be completely closed.

As described more fully in the aforementioned patent U.S. Pat. No. 6,635,370, with proper control of the shut down process, equilibrium of the gases in the anode and cathode can be achieved with hydrogen concentration between about nil and 50%. To counteract the introduction of oxygen during storage, the fuel recycle blower can be turned on periodically, and the hydrogen concentration in the recycle gas monitored. Should the hydrogen concentration drop below some predetermined percentage, additional fresh hydrogen can be added. In this way, the fuel cells are at rest with an adequate hydrogen concentration to prevent corrosion of the catalyst during storage.

The fuel cell system is now considered shut down, which is hereinafter sometimes referred to as in “storage”, until the system is restarted and the primary load is reconnected. The foregoing procedure may employ a dedicated cathode gas recycle blower as in the aforementioned '370 patent.

In the just-described method of shutting down a fuel cell system of the type shown in FIG. 1, the air inlet valve 139a was left completely, or at least partially open to ensure that there would be no vacuum, of any magnitude, for any period of time during the shutdown procedure. Any reduction in oxygen caused by reaction within the cathode flow field channels 122 will result in a negative pressure differential across the valve 141a so a small amount of atmospheric air will enter the recycle loop 133 through valve 139a or valve 141a, as the case may be.

If desired, check valves (not shown) may be provided between atmosphere and the air conduit 139 and the fuel conduit 160, to further ensure that no vacuum is created in the anode or the cathode during shut down, thereby avoiding drawing coolant from the channels 103 into the anode or cathode gas spaces. As the shut-down is being completed, the valves 139a, 141a, 158 and 162 are all closed.

During the startup procedure after the fuel cell stack has been stored with a hydrogen concentration of up to about 50%, the procedure begins with the introduction of a controlled amount of air to the cathode which displaces an equal amount of hydrogen-containing gas through the cathode outlet manifold and into the fuel cell vent. Safety regulations specify that discharges of hydrogen may pose a risk factor if the level of hydrogen exceeds the 4% level; this is known as the lower flammability limit. The present process causes the residual storage hydrogen to be principally consumed within the fuel cell cathodes, where the catalyst in each cell allows for a catalytic combustion so that the vent gases remain low in hydrogen content. In addition, during this procedure the adjacent cell coolant ensures removal of a significant fraction of the heat of combustion which occurs.

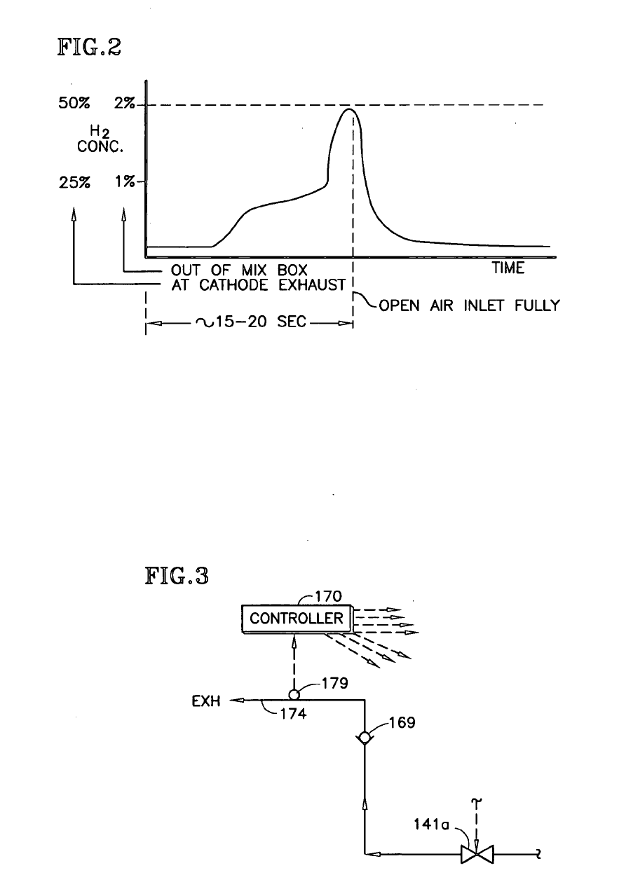

The processed forth below is for a fuel cell power plant startup procedure where hydrogen is present in the cathode gas passages. This startup procedure for a fuel cell power plant is under command of a controller 170 and it comprises:
initiating the flow of hydrogen on the anode side by opening valve 158 with the voltage limiting device auxiliary load 150 in place;
once hydrogen is established on the anode, removing the VLD 150;
next opening the cathode recycle valve 135;
opening the inlet valve 139a to ˜50% value. The set point is chosen so that make up air will be readily available as the vent is periodically open while turning on air blower 144;
next pulse-opening (that is, opening repetitively for short periods of time) the cathode exit valve 141a to balance (a) the need to consume the residual hydrogen in the fuel cell cathode as efficiently as possible while (b) also limiting the hydrogen purged from the fuel cell exit so that hydrogen concentration measured at the exit remains below the LFL limit. The controller meters (and, if pulses, modulates) the pulsed (or steady) exit flow from the cell based on the known flow rate of the air purge in the mix box and the feedback from the hydrogen sensor, until the exit flow at the hydrogen sensor has reached and passed a maximum (which is not usually as high as shown in FIG. 2).

At this point the power plant is ready to proceed with normal operation where the cathode recycle is off and the exit valve 141a is fully open. This process avoids having an excessive peak hydrogen concentration (i.e., a concentration of greater than 4%) impelled by incoming air through the cathode exhaust manifold and out the fuel cell exit.

In the embodiment of FIG. 1, the cathode exhaust flows through the valve 141a and the check-valve 169 (although both valves may not be necessary) to a mix box 173. The mix box may be an enclosure for a substantial portion of a fuel cell power plant, such as a cabin ventilation system of a vehicle, which collects any gases leaking from the stack, mixes the gases with fresh air, and dispels them to exhaust 174 to ensure that the level of hydrogen is well below the lower flammability level (about 4%). Air is passed through the mix box by a fan 176.

The mix box 173 could also be an exhaust gas mixing chamber of some other construction. Without a mix box 173, the hydrogen sensor 189 senses the hydrogen concentration in the exhaust 174. FIG. 3 illustrates that the present arrangement can be used in a fuel cell power plant which does not have a mix box 173. In that case, the hydrogen sensor 179 reflects hydrogen concentrations leaving the cathode, which are significantly greater, ranging up to about 50% as indicated in FIG. 2. For this process to work, considerable more time would be required in the air recycle mode in order to consume the hydrogen remaining in the cathode flow fields before purging at the exit can take place Use of pulses and cathode recycle will help in cases where an air-diluting mix box is not used.

Referring to FIG. 2, hydrogen concentration is plotted as a function of time. It can be seen that there is initially virtually no hydrogen being vented out of the cathode exit ahead of the air which is entering the cathode as soon as the valve 139a is opened a small amount. However, eventually the hydrogen concentration increases, and is reflected in the higher reading from the sensor. The rate of change in the hydrogen concentration is dependent on many factors including gas flow rates, hardware configurations and plumbing line sizes etc. Regardless of the specific shape of the curve, the key factor is that the peak level of hydrogen concentration never exceeds a setpoint limit, in this case 2% hydrogen or 50% of the LFL, before the level completely decreases to back to the initial level of virtually no hydrogen being vented out of the cathode exit. Thus, it is clear that the hydrogen is essentially out of the cathode as soon as the peak has been passed. At that time, the controller will sense that the concentration is past peak, and will then be able to open the air inlet fully so that a startup procedure may continue:

This arrangement is particularly advantageous, and the description relates to, a situation where the fuel cell has been shut down for only a short time such as for several minutes. If the fuel cell is shutdown over a longer period of time, reactant gases, especially hydrogen, tend to leak out, or be consumed in the cells, so that unless there is hydrogen replenishment during power plant shutdown, the arrangement herein is not as vital, but it may still be used to ensure a safe start up.

1. A method characterized by:
during a startup procedure for a fuel cell power plant (100),
(a) allowing gas in outlets (126) of oxidant flow fields (122) of fuel cells (102) in said fuel cell power plant to flow to exhaust (174);
characterized by:
(b) providing (139, 139a, 144) to inlets (124) of said oxidant flow fields a flow of air from a source (142) which is less than a flow of air utilized during normal operation of the power plant;
(c) monitoring (170, 179) the hydrogen concentration in the gas flowing from said outlets to exhaust; and
(d) providing to said inlets a flow of air utilized during normal operation of the power plant in response to the hydrogen concentration having reached and passed a peak concentration.

2. A method according to claim 1 characterized in that:
said step (b) comprises providing (139, 139a, 144) a flow of air which is about one-half the flow of air utilized during normal operation of the power plant.

3. A method according to claim 1 characterized in that:
said step (b) comprises repetitively providing (139, 139a, 144) flows of air of short duration.

4. A method according to claim 1 characterized in that:
said step (a) comprises allowing gas in said outlets (126) to flow through a gas mix box (173) to exhaust (174); and
said step (c) comprises monitoring (170, 179) the concentration of hydrogen in gas flow at the outlet of said mix box.

5. A method according to claim 1 further characterized by:
following said step (d), flowing (158, 160, 162) fuel gas (140) to the anodes (128) of said fuel cell power plant.

6. A method according to claim 1 further characterized by:
prior to said step (c), enabling (135) a cathode gas recycle loop (133, 144) to return gas from said outlets (126) to said inlets (124) of said oxidant flow fields (122).

7. A method according to claim 1 characterized in that:
said step (d) follows said step (a) by between about 5 seconds and about 30 seconds.

8. A method according to claim 1 characterized in that:
said step (d) follows said step (a) by between about 15 seconds and about 20 seconds.
